(19) United States
(12) Patent Application Publication
(10) Pub. No.: US 2020/0342372 A1
(43) Pub. Date: Oct. 29, 2020

(54) GENERATION OF GEOSPATIAL IMAGES REPRESENTING DISRUPTED COMMODITY FLOWS BETWEEN REGIONS FOR USER-DEFINED SCENARIOS SPECIFIED VIA A GRAPHICAL USER INTERFACE

(71) Applicant: Arizona Board of Regents on Behalf of Northern Arizona University, Flagstaff, AZ (US)

(72) Inventors: Benjamin Lyle Ruddell, Flagstaff, AZ (US); Richard Rushforth, Flagstaff, AZ (US); Jon Miller, Tempe, AZ (US); Rahul Salla, Tempe, AZ (US); Erzhena Soktoeva, Tempe, AZ (US); Ramesh Gorantla, Tempe, AZ (US)

(21) Appl. No.: 16/862,256

(22) Filed: Apr. 29, 2020

Related U.S. Application Data
(60) Provisional application No. 62/840,057, filed on Apr. 29, 2019.
(60) Provisional application No. 62/840,084, filed on Apr. 29, 2019.

(51) Int. Cl. G06Q 10/06; G06F 3/0484; G06F 16/13

(52) U.S. Cl. CPC G06Q 10/0631; G06F 16/13; G06F 3/0484

(57) ABSTRACT

Systems and methods for producing geospatial images representing flows of commodities between geographic regions and their dependencies are disclosed. Raw economic and other data associating with discrete geographic locations are combined with data metadata from other sources, including transportation network data. Images may be generated at user-specified degrees of commodity category granularity and geographic granularity and may be contain information at significantly higher degree of geographic granularity than the original raw economic data. Quantities of flows are represented graphically by parameters such as widths of lines, paths, or other graphic elements.

### CROSS-REFERENCE TO RELATED APPLICATIONS

This application claims the benefit of U.S. Provisional Patent Application No. 62/840,057 filed on Apr. 29, 2019, entitled “Generating Geospatial Commodity Flow Datasets with Increased Spatial Resolution From Coarsely-Resolved Economic Datasets” and also claims the benefit of U.S. Provisional Patent Application No. 62/840,084 filed on Apr. 29, 2019, entitled “Generation of Geospatial Images Representing Disrupted Commodity Flows Between Regions for User-Defined Scenarios Specified via a Graphical User Interface.” The disclosure of each of the above-referenced applications is incorporated herein by reference.

### STATEMENT REGARDING FEDERALLY-FUNDED RESEARCH

This invention was made with government support under Award 1639529 awarded by the National Science Foundation. The government has certain rights in the invention.

### BACKGROUND OF THE INVENTION

Conventional approaches to analyzing and generating a visual representation of economic data typically comprise gathering datasets with relevant information and plotting that data. When the data contain geographic references, the data may be visualized geographically as a heatmap overlaid on a map, for example. The spatial resolution of such visualizations is typically limited to the spatial resolution of the underlying dataset. Models and predictions made using such data are also typically constrained to the same degree of spatial granularity as the data or even lower.

### BRIEF SUMMARY

In one embodiment, a system comprises a database server, a communication network coupled to the database server, a user device coupled to the communication network, and a rendering server. The database server is configured to provide remote access to a set of electronic datastores that store global resource flow records and localized resource records. Each global resource flow record indicates an origin, destination, quantity, and classification of resources transferred between the origin and destination regions belonging to a set of geographic regions. The global resource flow records have a first level of geographic granularity and identify resources at a first level of category granularity. The localized resource records indicate quantities of resources consumed or produced in sub-regions within the set of geographic regions. The localized resource records have a second level of geographic granularity greater than the first level of geographic granularity and a second level of category granularity greater than or equal to the first level of category granularity.

The user device comprises a processor, a display device coupled to the processor; and memory coupled to the processor storing instructions. The instructions, when executed by the processor cause the processor to provide a user interface via the display device; receive an initial geospatial image within the user interface; receive user inputs directed toward image coordinates of the geospatial image; generate user interaction signals that encode the image coordinates and analysis commands identifying a target resource and requested transformations of the initial geospatial image; transmit the user interaction signals and the analysis commands to a remote server; and display a geospatial data image that fuses the initial geospatial image with geospatially-represented data elements, the geospatial data image representing results of the requested analysis.

The rendering server comprises processing circuitry, a communications interface coupled to the processing circuitry and the communications network; and memory coupled to the processing circuitry. The memory of the rendering server stores rendering instructions that, when executed by the processing circuitry, cause the processing circuitry to receive the user interaction signals from the user device; determine a geographic extent for the geospatial data image using the user interaction signals; and determine a target region within the set of geographic regions. The rendering instructions, when executed to determine the target region, cause the processing circuitry to access boundary data describing boundaries within the set of geographic regions; and output, as the target region, a sub-region specified at a third level of geographic granularity greater than the first level of geographic granularity and belonging to a first region within the set of geographic regions that includes the image coordinates.

Executing the rendering instructions further causes the processing circuitry to calculate, using the global resource flow records, resource flows of the target resource to the first region from each of set of sources for the target resource; and transform the calculated resource flows of the target resource to the first region into graphic representations of resource flows of the target resource to the target region. The rendering instructions, when executed transform the calculated resource flows of the target resource to the first region into graphic representations of resource flows of the target resource to the target region, cause the processing circuitry to determine, using the localized resource records, a total flow of the target resource to the target region from the set of sources for the target resource; determine, using the total flow of the target resource to the target region and the calculated resource flows of the of the target resource to the first region, a set of flows of the target resource to the target region corresponding to the set of sources for the target resource; and generate, for each flow of the target resource to the target region, a set of coordinates forming one or more paths from a source of that flow to the target region in a coordinate system of the initial geospatial image. Each path has a width parameter determined by a magnitude of that flow of the target resource to the target region;

Executing the rendering instructions further causes the processing circuitry to render the geospatial data image by replacing pixel color values of pixels at coordinates of each path in the initial geospatial image with a color value absent from the initial geospatial image; and transmit the geospatial data image to the user device.

In another embodiment, a system comprises processing circuitry and memory coupled to the processing circuitry. The memory stores instructions that, when executed by the processing circuitry, cause the processing circuitry provide a user interface to a user device. The user interface configured to display geospatial images and capture interactions of a user with the geospatial images. Executing the instructions further causes the processing circuitry to retrieve, from an electronic datastore, global resource flow records and localized resource records. Each resource flow record indicates an origin, destination, quantity, and classification of resources transferred between the origin and destination regions belonging to a set of geographic regions, the global resource flow records having a first level of geographic granularity and identifying resources at a first level of category granularity. The localized resource records indicate quantities of resources consumed or produced in sub-regions within first set of geographic regions. The localized resource records have a second level of geographic granularity greater than the first level of geographic granularity and a second level of category granularity greater than or equal to the first level of category granularity.

Executing the rendering instructions further causes the processing circuitry to transmit an initial geospatial image to the user device via the user interface representing the first set of geographic regions; receive, from the user device via the user interface, user interaction signals encoding image coordinates and analysis commands identifying a target resource and requested transformations of the initial geospatial image; determine a geographic extent for a geospatial data image using the user interaction signals; and determine a target region within the set of geographic regions. The instructions, when executed to determine the target region within the set of geographic regions, cause the processing circuitry to access boundary data describing boundaries within the set of geographic regions; and output, as the target region, a sub-region specified at a third level of geographic granularity greater than the first level of geographic granularity and belonging to a first region within the set of geographic regions that includes the image coordinates.

Executing the instructions further causes the processing circuitry to calculate, using the global resource flow records, resource flows of the target resource to the first region from each of set of sources for the target resource; and transform the calculated resource flows of the target resource to the first region into graphic representations of resource flows of the target resource to the target region. The instructions, when executed to transform the calculated resource flows of the target resource to the first region into the graphic representations of resource flows of the target resource to the target region, cause the processing circuitry to determine, using the localized resource records, a total flow of the target resource to the target region from the set of sources for the target resource; determine, using the total flow of the target resource to the target region and the calculated resource flows of the of the target resource to the first region, a set of flows of the target resource to the target region corresponding to the set of sources for the target resource; and generate, for each flow of the target resource to the target region, a set of coordinates forming one or more paths from a source of that flow to the target region in a coordinate system of the initial geospatial image. Each path has a width parameter determined by a magnitude of that flow of the target resource to the target region.

Executing the instructions further causes the processing circuitry to render the geospatial data image by replacing pixel color values of pixels at coordinates of each path in the initial geospatial data image with a color value absent from the initial geospatial image; and transmit the geospatial data image to the user device.

In another embodiment, a method comprises providing a user interface to a user device. The user interface is configured to display geospatial images and capture interactions of a user with the geospatial images. The method further comprises retrieving global resource flow records and localized resource records from an electronic datastore. Each resource flow record indicates an origin, destination, quantity, and classification of resources transferred between the origin and destination regions belonging to a set of geographic regions. The global resource flow records have a first level of geographic granularity and identify resources at a first level of category granularity. The localized resource records indicating quantities of resources consumed or produced in sub-regions within first set of geographic regions and the localized resource records have: a second level of geographic granularity greater than the first level of geographic granularity and a second level of category granularity greater than or equal to the first level of category granularity.

The method further comprises transmitting a geospatial data image to the user via the user interface representing the first set of geographic regions; receiving, from the user device via the user interface, user interaction signals encoding image coordinates and analysis commands identifying a target resource and requested transformations of the initial geospatial image; determining a geographic extent for a geospatial data image using the user interaction signals; and determining a target region within the set of geographic regions. Determining the target region within the set of geographic regions comprises accessing boundary data describing boundaries within the set of geographic regions; and outputting, as the target region, a sub-region specified at a third level of geographic granularity greater than the first level of geographic granularity and belonging to a first region within the set of geographic regions that includes the image coordinates.

The method further comprises calculating, using the global resource flow records, resource flows of the target resource to the first region from each of set of sources for the target resource; and transforming the calculated resource flows of the target resource to the first region into graphic representations of resource flows of the target resource to the target region. transforming the calculated resource flows of the target resource to the first region into graphic representations of resource flows of the target resource to the target region comprises determining, using the localized resource records, a total flow of the target resource to the target region from the set of sources for the target resource; and determining, using the total flow of the target resource to the target region and the calculated resource flows of the of the target resource to the first region, a set of flows of the target resource to the target region corresponding to the set of sources for the target resource; and generating, for each flow of the target resource to the target region, a set of coordinates forming one or more paths from a source of that flow to the target region in a coordinate system of the initial geospatial image, each path having a width parameter determined by a magnitude of that flow of the target resource to the target region.

The method further comprises rendering the geospatial data image by replacing pixel color values of pixels at coordinates of each path in the initial geospatial data image with a color value absent from the initial geospatial image; and transmitting the geospatial data image to the user device.

The above features and advantages of the present invention will be better understood from the following detailed description taken in conjunction with the accompanying drawings.

### BRIEF DESCRIPTION OF THE DRAWINGS

The drawings described herein constitute part of this specification and includes exemplary embodiments of the present invention which may be embodied in various forms. It is to be understood that in some instances, various aspects of the invention may be shown exaggerated or enlarged to facilitate an understanding of the invention. Therefore, drawings may not be to scale.

FIG. 1A depicts an example environment in which embodiments disclosed herein may be used.

FIG. 1B depicts further details of FIG. 1A according to certain embodiments.

FIGS. 2A-2D are flow diagrams of example procedures performed according to embodiments disclosed herein.

FIG. 3 depicts a flow diagram of methods forming part of an example embodiment.

FIG. 4 depicts selected elements of FIG. 3 in greater detail.

FIG. 5 depicts an example image produced as part of embodiments disclosed herein.

FIG. 6 depicts an example user interface in certain embodiments.

FIG. 7 depicts an example procedure for responding to user input in certain embodiments.

FIG. 8 depicts an example computation workflow in certain embodiments

FIG. 9 depicts an example data image representing commodity-and-resource flows generated in certain embodiments.

FIG. 10 depicts an example comparison generated in certain embodiments between two data images representing commodity-and-resource flows.

FIGS. 11-13 show example data images of analytic metrics on different scales generated and presented in embodiments described herein.

### DETAILED DESCRIPTION

The described features, advantages, and characteristics may be combined in any suitable manner in one or more embodiments. One skilled in the relevant art will recognize that the circuit may be practiced without one or more of the specific features or advantages of a particular embodiment. In other instances, additional features and advantages may be recognized in certain embodiments that may not be present in all embodiments.

Reference throughout this specification to “one embodiment,” “an embodiment,” or similar language means that a particular feature, structure, or characteristic described in connection with the embodiment is included in at least one embodiment. Thus appearances of the phrase “in one embodiment,” “in an embodiment,” and similar language throughout this specification may, but do not necessarily, all refer to the same embodiment.

Conventional systems and methods for analyzing the flows of commodities and resources and their interdependencies are limited to the lowest spatial resolution of underlying datasets. Additionally, conventional systems and methods require users desiring to simulate expected results of disruptions in those flows to write instructions (or software code) in specialized formats in order to produce simulated data.

Accordingly, the present disclosure addresses these and other shortcomings by producing synthesized datasets using multiple sources of economic or other data and then generating data images which geospatially encode synthesized commodity-and-resource flow data with an increased degree of geographic granularity (i.e., spatial resolution), achieved by novel “down-sampling” approaches which make use of additional metadata (e.g., economic, geographic, and/or transportation network data with higher degrees of granularity than the original dataset(s)). The present disclosure also includes systems and methods for processing and presenting the aforementioned flow data in the form of human-perceptible geospatial data images which may be provided with a graphical user interface (GUI) which allows users to specify analyses and simulations by interacting with data images within the GUI.

It should be understood that, although the Specification may separately reference “commodities” and “resources,” “goods,” and “services” these and other terms may in some instances or embodiments be treated equivalently. Water and electricity for example, may be thought of as both a resource used for production and transportation of commodities as well as commodities which are themselves bought, sold, and transported. Thus in some embodiments, resources may be treated as commodities in one or more analysis steps either programmatically, or in response to user input. Similarly, the term “flow” may be used generally to refer patterns of exchange or transportation of any of the above.

Furthermore, although the examples herein are directed toward economic data, it should be understood that they are for the purposes of illustration and are not intended to limit the scope of the systems and methods disclosed to economic data. The systems and method disclosed may be used to analyze, synthesize, and present other data, including, as non-limiting examples, weather-related data, traffic data, geographic data, legal/legislative data, and population/census data.

In the context of this disclosure, a resource flow may be understood as a quantity of a resource transported to or from a first region or location (an “origin” or “source”) to a second region or location (a “destination” or, in the context of a destination-focused analysis task, a “target region”). Accordingly the phrase “total flow” indicates a summation of resource quantities associated with resource flows to or from a particular region or location. It should be understood that, although examples make reference to flows from multiple regions said to “produce” resources to a particular region that may be said to “consume” those resources, that nothing herein should be construed as limiting embodiments to such arrangements. For instance, a region that outputs resources to other regions may be treated as a destination of resource flows having a revered direction or a negative associated quantity of resources. Similarly nothing should be interpreted as limiting the disclosure to analysis of flows terminating and/or originating at a single location or region (i.e., a “one-to-many” arrangement or “many-to-one” arrangement of resource flows).

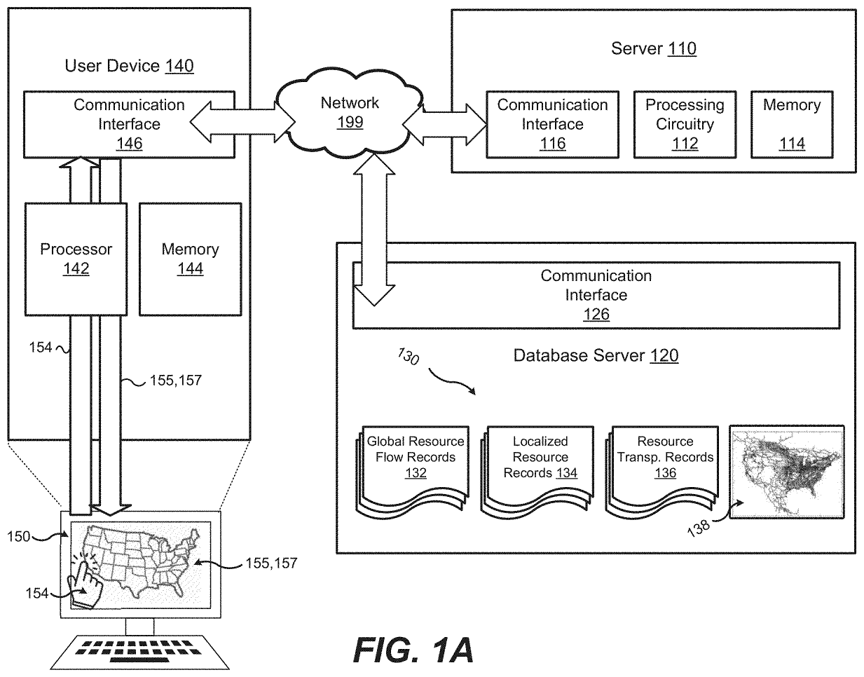

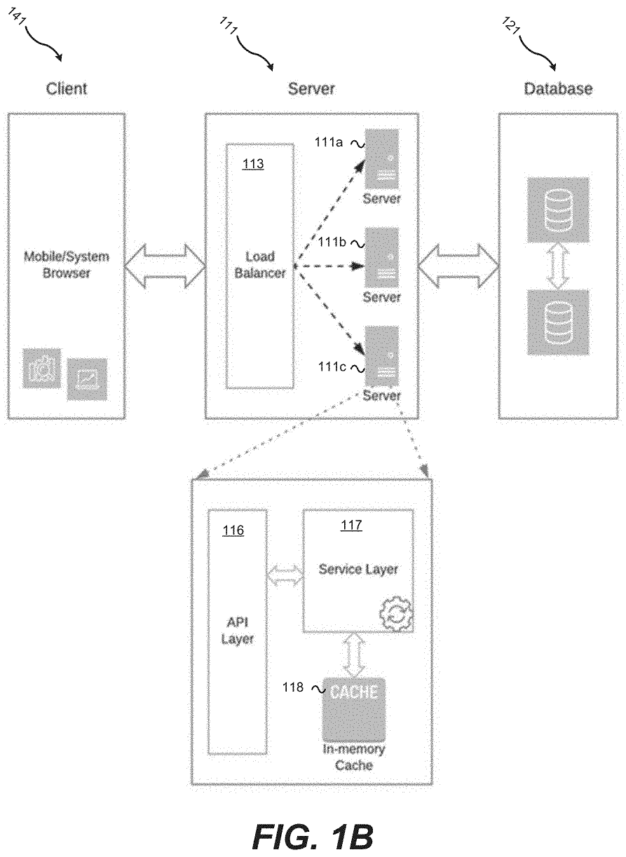

FIG. 1A shows an example environment in which embodiments may be practiced. In this example, a system 100 includes a server 110, a database server 120, a user device 140, and a network 199 via which these components communicate as described below. The server 110 has processing circuitry 112 and memory 114 coupled to the processing circuitry 112, and a communication interface 116 coupled to the processing circuitry 112. The memory 114 stores executable instructions which, when executed, cause the processing circuitry 112 to perform methods described herein. The database server 120 includes a communication interface 126 and is configured to store and provide access to various data 130, non-limiting examples of which include global resource flow records 132, localized resource records 134, resource transportation records 136, and one or more transportation network images 138.

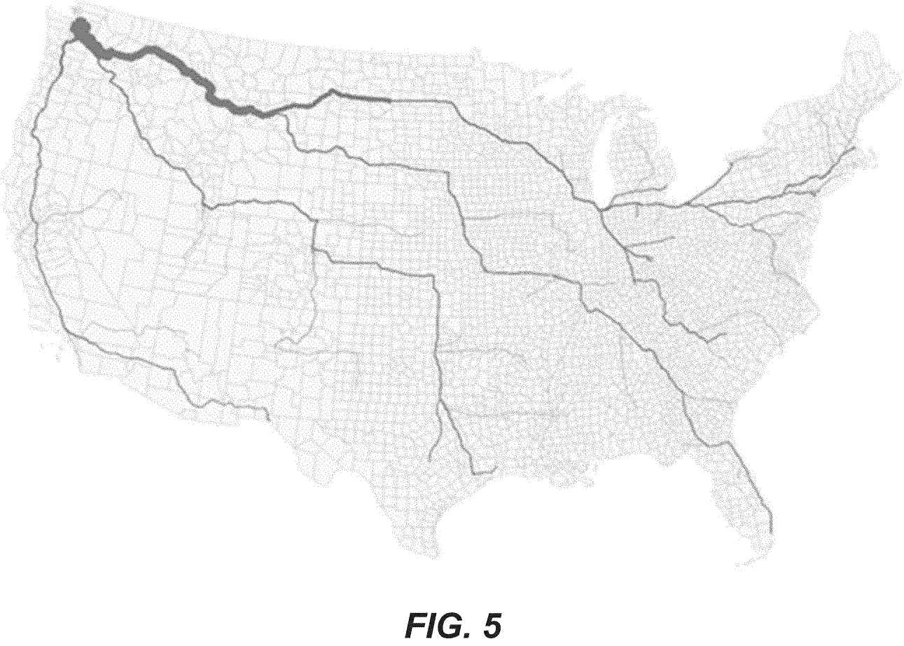

In this example, the global resource flow records 132 describe production and/or consumption of resources (examples of which are described further below) associated with geographic regions. These records may specify resources broadly in terms of high-level categories (e.g., dairy products rather than milk and cheese) and may specify the geographic regions producing or consuming those resources at a relatively high level (e.g., at the US state-level or at the county level within US states). Such high-level categorization of geographic regions and resources are described herein as having a low level or degree of granularity. Data with a low level of granularity may also be said to have a “low” or “coarse” resolution. Meanwhile, higher granularity data may be said to have “higher” or “finer” resolution. For example, a set of geographic regions defined at the level of US states would have a lower level of granularity than geographic regions described at the level of individual cities. Thus, data distinguishing regions at the city level would be said to have higher or finer resolution than data distinguishing regions only at the state level. The localized resource records 134 indicated production and/or consumption specified with greater granularity the global resource flow records 132. For example, the localized resource records 134 may specify consumption and/or production at a greater level of geographic granularity and/or may specify resources at a greater level of category granularity. The resource transportation records 136 store information that may be utilized to determine how resources are transported. For example the resource transportation records 136 may specify transportation modalities (or distributions thereof) used to transport various resources. The transportation network image 138 is a geospatial representation of transportation networks and may include metadata identifying transportation modalities associated with various segments of the depicted networks (e.g., rail, truck, et al.). The resource transportation records 136 may be used together with the transportation network image 138 to determine paths of resource flows between geographic regions and generated geospatial representations thereof (such as the example described below in connection with FIG. 5).

The user device 140 includes a processor 142, memory 144 coupled to the processor 142, and a communication interface 146 coupled to the processor 142. The memory 144 may store instructions which, when executed by the processor 142 cause the processor 142 to provide a graphical user interface 150 configured to display geospatial images 155, 157 as described further below, and also configured to receive and process user interactions 154 (depicted by a hand-shaped cursor icon). The server 110, database server 120, and the user device 140 may utilize their respective communication interfaces 116, 126, 146 to communicate via the communication network 199, or via any suitable arrangement of networks or interconnections.

FIG. 1B shows further details of the environment of FIG. 1A according to one embodiment. In this example, the FEWSION system runs on a server 111 (shown here as a distributed server including multiple individual servers 111a,b,c managed by a load-balancer 113). This distributed server 111 accesses information and stores information through a database system 121. The server 111 may retrieve information from external systems and store that data for future access using the database system 121. Users may interact with the system using client devices such as the client 141 (shown as a mobile device or browser) to perform analyses and display results.

The server 110 may be configured to provide an initial geospatial image 155 to a user of the user device 140 via the user interface 150. The user may interact with the initial geospatial image 155 and select one or more geographic target regions as part of a requested analysis. The user may, for example, click on a region, draw a curve around a region, or designate a region using any other suitable operations or gestures. The user device 140 may convert such user interaction(s) 154 into coordinates defined in a coordinate system of the initial geospatial image 155. The user device may relay signals such as the user interaction(s) 154 to the server 110 which may determine data required to perform requested analyses and retrieve that data from electronic datastores such as the database server 120. The server 110 may then transmit geospatial data images 157 representing the results of requested analyses.

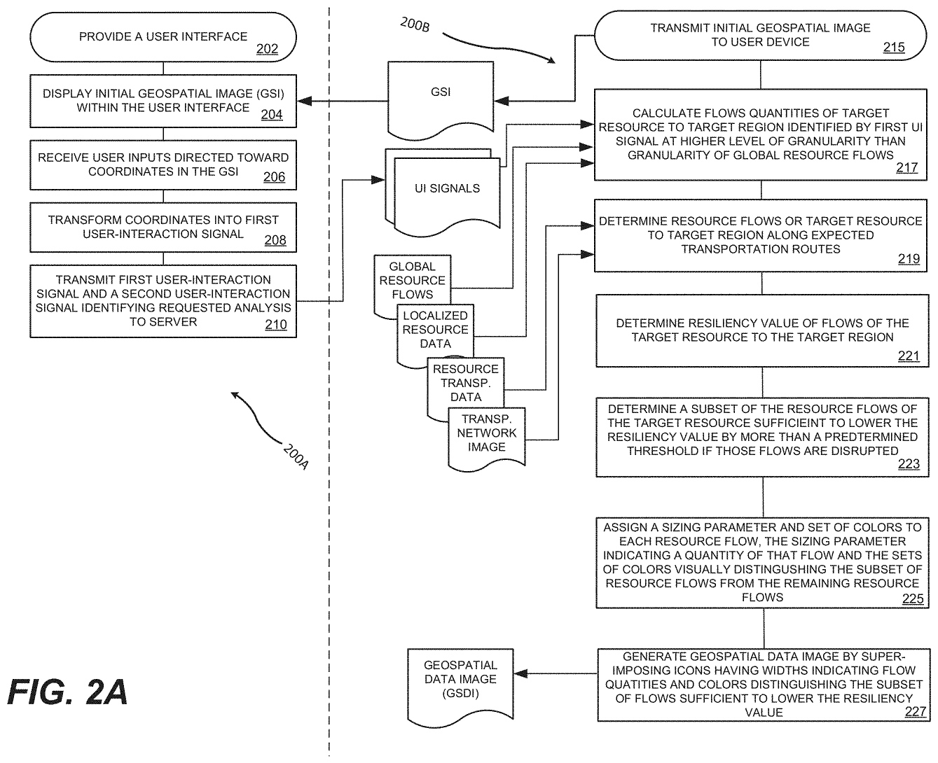

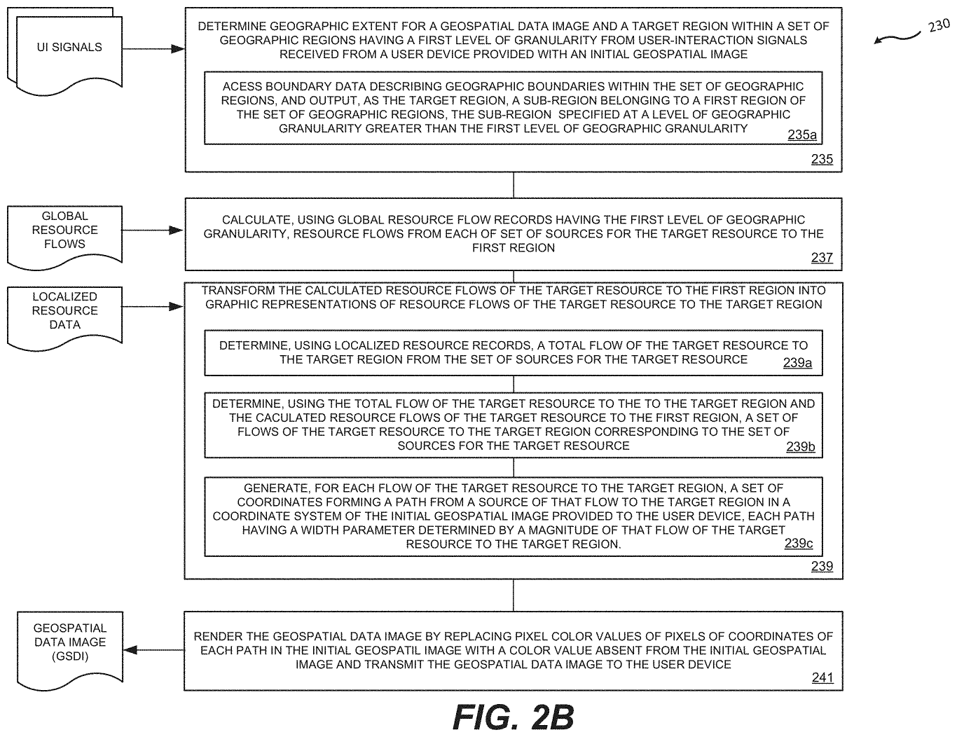

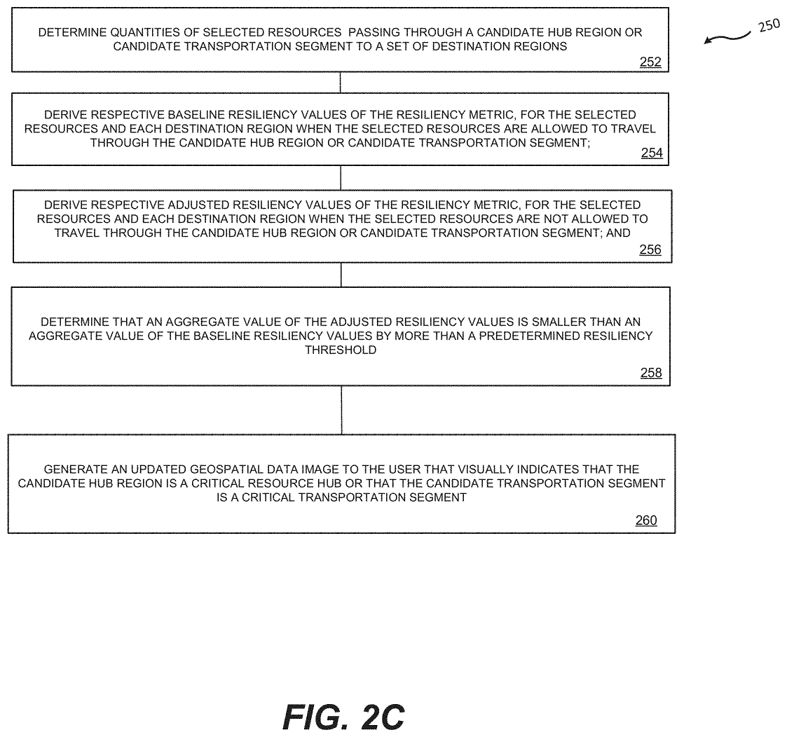

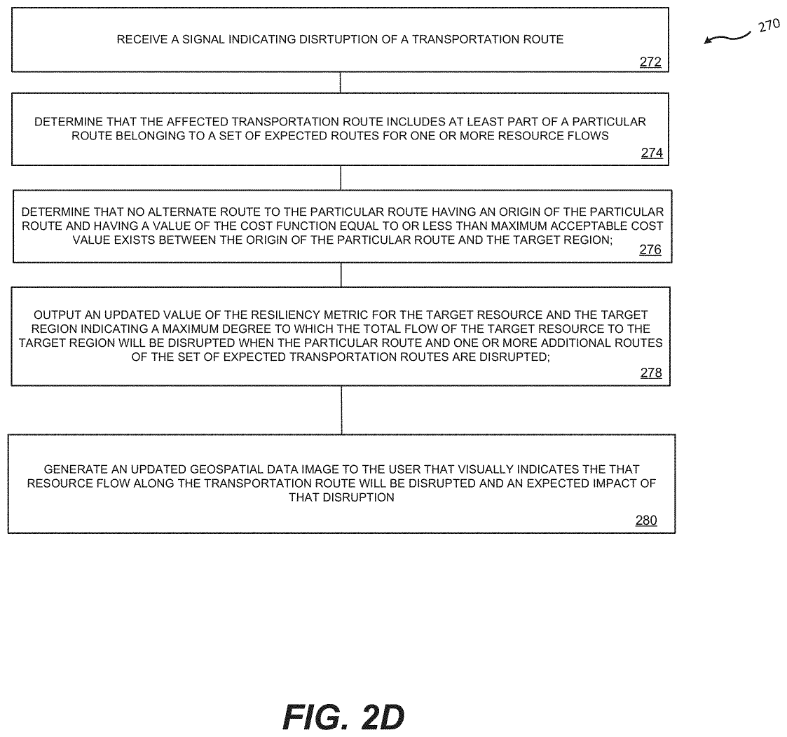

FIG. 2A depicts example procedures 200A,B which may be carried out a system such as the system 100 of FIG. 1A and its components. For example, procedure 200A may be carried out by a user device (e.g., the user device 140) and procedure 200B may be carried out by a server (e.g., the server 110). Procedure 200A includes steps 202, 204, 206, 208, 210 and procedure 200B includes steps 215, 217, 219, 211, 223, 225, and 227. In some embodiments, the same system or subsystem may perform both procedures 200A,B.

At step 202, a system (or subsystem) such as the user device 140 provides a user interface (e.g., the user interface 150) which may be configured to display geospatial images and capture interactions of the user with the geospatial images via the user interface. At step 204, the system displays an initial geospatial image (“GSI,” e.g., the initial geospatial image 155) within the user interface. The initial GSI may be received from another system or subsystem (e.g., the server 110). At step 206, the system receives user inputs via the user interface directed toward coordinates in the GSI, such as a mouse-click occurring within the bounds of a designated region within the image. At step 208, the system transforms those coordinates into a first user interaction signal (e.g., the user interaction signal 154). The initial GSI may be a representation of a set of geographic regions alone or the initial GSI may already represent results of previous analyses in addition to depicting the set of geographic regions.

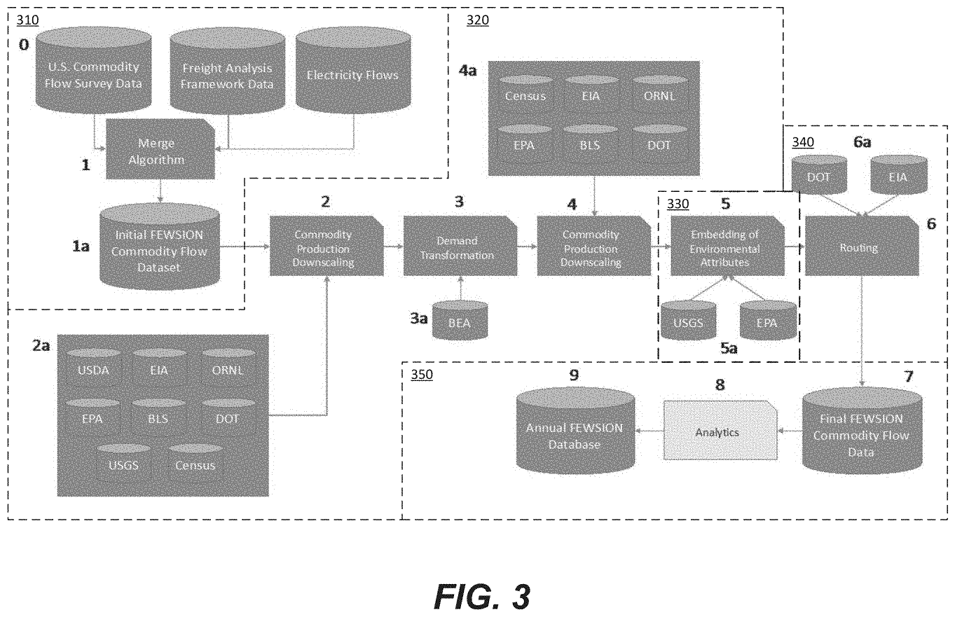

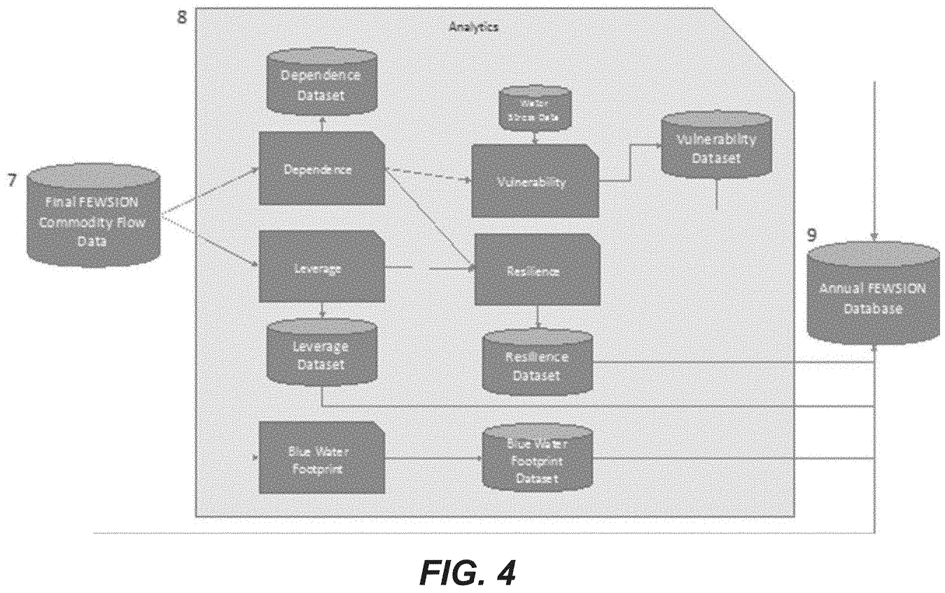

The example procedure 200B may be performed in conjunction with the procedure 200A or independently. At step 215, a system (or subsystem) such as the server 110 transmits an initial geospatial image (e.g., the geospatial image 155) to a user device such as the user device 140 (or any other suitable device). At step 217 the system receives user interaction signals (“UI signals”) may contain information that may be used to identify regions of the geospatial image (as described above) and information requesting a particular analysis task. For example, procedure 200B, as described further below performs the task of identifying flows of one or more selected resources (e.g., water supplies, electricity supplies, and/or industrial/consumer goods, as non-limiting examples) to a target region within a larger geographical area forming all or part of an initial geospatial image (e.g., a map of the United States, a subregion consisting of multiple states, a single county, etc.) and further determining how resilient those flows are to potential disruptions due to natural disasters or other events which may affect transportation networks, production facilities, and so on. Using the UI signals as described above, the system may access global resource flow data having a first level of geographic granularity and combine those data with localized resource data at a higher level of granularity, manipulating and transform these and other data (as described further below in connection with FIGS. 3-4) in order to first determine quantities of resource flows of the target resource to the target region despite the fact that the global resource flow records may only measure flows for a larger region than the target region and/or for resources categorized at a lower level of granularity than that of a specific target resource.

At step 219, the system determines expected routes of inferred flows of the target resource to the target resource using resource transportation data (e.g. the resource transportation records 136) that associates resources with transportation modalities used to transport those resources to and from different origin-destination pairs and a transportation network image (e.g., the transportation network image 138 depicted in FIG. 2A represented transportation networks within the continental United States, as a non-limiting example). Various suitable methods may be employed to determine expected transportation routes. In some embodiments, the system may determine quantities or proportions of quantities of the target resources(s) transported by each of a set of transportation modalities. The system may then use metadata associated with coordinates in the transportation network image to calculate a cost function for different routes, choosing routes which minimize or otherwise optimize that cost function as expected transportation routes for the target resource(s) from sources of those resources to the target region. As a non-limiting example, interstate highway segments may have a lower cost/mile associated with them when compared to state highways or smaller roads. Accordingly, routes that maximize travel along interstates will tend to be more likely expected routes as long as those routes do not dramatically increased total mileage between a given source region and the target region for a given target resource.

At step 221, after expected transportation routes for all flows of the target resource to the target region have been determined, the system may determine a value of a resiliency metric that indicates how resilient supply of the target resource to the target region is in response to potential disruptions of one or more flows. In some embodiments, this resiliency metric may be calculated using an entropy-based calculation such as the Shannon diversity, as a non-limiting example. The higher the resiliency score for a combination of target resource and target region, the less likely a disruption in any single transportation route or and/or production source will dramatically impact supplies of the target resource to a target region. A system may perform additional operations to aid in understanding or visualizing the resiliency of a target region with respect to one or more target resources.

Along these lines, at step 223 a system may determine a subset of the resources flows to the target region that, if disrupted would lower the resiliency score for the remaining resource flows to the target region by greater than a predetermined threshold. In some embodiments, a system performing this step may identify a minimal subset of the resource flows sufficient to lower the value of the resiliency metric by more than the threshold, thereby enabling the system to provide an intuitive indication of how vulnerable flows to a target region are to disruptions.

At step 225, a system may assign a sizing parameter to each resource flow to the target region that is related to a quantity of that resource flow. The relationship between the quantity of a resource flow and the corresponding sizing parameter may be monotonically increasing with increasing quantity such that larger flows are assigned larger values of the sizing parameter. At step 225, each resource flow is also assigned a set of color values. Different color values may be assigned to the subset of resource flows determined at step 223 and the remaining resource flows to the target region, thereby enabling generation of geospatial data image (e.g., the geospatial data image 157) that visually represents the relative sizes resource flows to the target region while also providing a visual indication of the most critical resource flows and the overall vulnerability of the target region disruption (the larger the subset of resource flows that must be disrupted to lower the resiliency score, the less vulnerable the target region is).

The example procedure 200B concludes at step 227 where a system may generate the geospatial data image visually representing the paths and relative sizes of the resource flows from sources of the target resource(s) to the target region, along with visual indications of the vulnerability of the target region. In order to generate the geospatial data image, the system may superimpose, on the initial geospatial image, icons having widths determined by the sizing parameters assigned at step 225 having colors that visually distinguish the subset of resource flows identified at step 223 (e.g., a minimal subset of the resource flows sufficient to lower the resiliency value for the target region if disrupted) from the remaining resource flows of the target resource(s) to the target region.

FIG. 2B depicts another example procedure 230 that may be performed by a system such as the server 110 having steps 235, 237, 239, and 241. Step 235 may include substep 235a and step 239 may include substeps 239a,b,c. At step 235 a system (or subsystem) may receive user interaction signals (e.g., the user interaction signals 154) from a user device and determine a geographic extent of a geospatial data image or “GSI” (e.g., the geospatial data image 157) using information from the user interaction signals received from a user a device. For example, a user device may be provided with an initial geospatial image (e.g., the initial geospatial image 155). A user of the user device may interact with the GSI via mouse-clicks, dragging, or other actions to select an area of interest within a larger area (e.g., a region or regions within a map of the United States as pictured schematically in FIG. 1A) including a set of geographic regions specified at a first level of geographic granularity as well as particular regions to include in an requested analysis task as well as a target resource for the analysis. The system may determine a that user has identified a sub-region at level of granularity higher than a level of a resource flow records available to the system, analogously to the descriptions above in connection with FIG. 2A. Accordingly the system may perform substep 235a and access boundary data describing geographic boundaries within the set of geographic regions. The system may then determine that the user interactions identify a sub-region as a target region for an analysis task.

At step 237 the system may retrieve global resource flow data (e.g., the global resource flow records 132) having a lower level of geographic granularity than the specification of the target region determined in step 235. The system may use the global resource flow data to calculate resource flows of a target resource identified by the user interaction signals which may be downsampled (as described in greater detail in connection with FIGS. 3-4 below). At step 239, the system may transform the resource flows to the first region having the first level of geographic granularity into graphic representations of resource flows of the target resource to the target region specified at a level of geographic granularity higher than the first level of geographic granularity (e.g., if the first level of geographic granularity corresponds to the state level, the target region may be a county within a state). At substep 239a, the system may use localized resource data (e.g., localized resource records 134) as described above to determine a total flow (i.e., a summed quantity) of the target resource to the target region. At substep 239b, the system may determine a set of flows of the target resource to the target resource from a set of corresponding sources of the target resource for flows to the first region via downsampling methods described below in connection to FIGS. 3-4. At substep 239c, the system may generate, for each flow of the target resource to the target region determined in substep 239b, a set of coordinates forming a path from the a source of that flow to the target region in a coordinate system of the initial geospatial image. Each path may have a width parameter determined by a magnitude of the corresponding flow of the target resource to the target region.

In some embodiments, the system may determine the paths by retrieving resource transportation data (e.g., resource transportation records 136) associating quantities of resources with transportation modalities used to transport those resources and transportation network image data (e.g., the transportation network image 138) representing transportation networks within the set of geographic regions. The transportation network image may have a level of geographic granularity greater than the level of geographic granularity of the set of geographic regions and the global resource flow data. The system may determine, for each flow belonging to the set of flows of the target resource to the target region, one or more expected transportation routes represented in the transportation network images for that flow using the resource transportation records and the transportation network images. The system may then assign a sizing parameter to each path that determines a width of that path. The sizing parameter for each path may be monotonically related to a quantity of resources flowing along that path. The system may then generate, for the target resource and each corresponding transportation modality, paths along transportation networks of the corresponding modality from source regions of the target resource to the target region that minimize a cost function. Finally, at step 241, the system may render a geospatial data image by replacing pixel color values of coordinates of each path in the initial geospatial image with a color value absent from the initial geospatial image, thereby visually distinguishing the paths from other geospatial information previously present in the initial geospatial image and transmit the geospatial data image to the user device.

A system (or subsystem) such as the server 110 may perform additional procedures in response to an instruction or request to perform an analysis to determine whether a region (which may range from a broad geographic region such as a city, county, or state, as non-limiting examples to an area that identifies a single facility such as a production plant, an airport, or even a single area or piece of equipment within such an area) is critical to the flow of a set of resources. The concept of a critical hub in a resource distribution system can also be applied to transportation routes. For example, a particular transportation segment (a length of road, a length or rail, an interchange, and so on) may be determined to be a critical transportation segment whose disruption is expected to interrupt supplies of resources and/or result in significantly reduced resiliency of supplies of those resources. The system may implement any suitable definition of whether an area is critical or not. Non-limiting examples include determining that any area which, if subject to disruption, would reduce the supply of a particular resource by more than a predetermined quantity or proportion may be critical. As another example, any area which, if subject to a disruption (which might be due to an accident, weather conditions, a natural disaster, economic conditions, and so on), would reduce the resiliency of a resource flows to a particular area more than a threshold may be deemed “critical.” It should be understood that, although the concept of a critical hub or a critical transportation segment in a network of resource flows is discussed herein, these concepts may be extended to other systems that may be represented by flows between regions which may have “hub-like” and “route-like” structures such as data networks, as one non-limiting example.

Along these lines, FIG. 2C depicts a procedure having steps 252, 254, 256, 258, and 260. At step 252, as system such as the server 110 determines quantities of selected resources passing through a candidate hub region or candidate transportation segment to a set of destination regions. This step may be performed in response to a request received from a user device (e.g. the user device 140 encoded in user interaction signals (e.g., user interaction signals 154). The system may determine the quantities using various data sources described previously and below or the system may utilize an existing geospatial data image (e.g., the geospatial data image 157) which already contains sufficient visually-represented resource flow information. At step 254, the system may derive respective baseline resiliency values of the resiliency metric for the selected resources and each destination region when the selected resources are allowed to travel through the candidate hub region or candidate transportation segment. The resiliency metrics may be calculated as described above and described further in connection to FIGS. 3-4, or using any other suitable methods. At step 256, the system may derive respective adjusted resiliency values of the resiliency metric, for the selected resources and each destination region when the selected resources are not allowed to travel through the candidate hub region or candidate transportation segment. At step 258 the system may determine that an aggregate value of the adjusted resiliency values is smaller than an aggregate value of the baseline resiliency values by more than a predetermined resiliency threshold. Finally, at step 260 the system may generate an updated geospatial data image to the user that visually indicates that the candidate hub region is a critical resource hub or that the candidate transportation segment is a critical transportation segment.

A system (or subsystem) such as the server 110 may perform additional procedures that include receiving additional information over time, including information relating to changes in previously analyzed resource flows over time. Such information may include real-time, near real-time, and/or other signals indicating disruption to resource flows originating or terminating within particular regions or conditions that will tend to disrupt resource flows, including weather conditions, natural disasters, and the like, as non-limiting examples.

Along these lines, FIG. 2D depicts a procedure 270 having steps 272, 274, 276, 278, and 280. At step 272, the system may receive a signal indicating disruption of a transportation route. The signal may indicate disruption of a route directly, or the signal may indicate a weather or other condition that system may predict will result in such a disruption. Predictions of disruptions may be generated using rules or any suitable predictive modeling techniques including, but not limited to, the use of machine learning algorithms trained on historical data. At step 274, the system may determine that the affected transportation route includes at least part of a particular route belonging to a set of expected routes for one or more resource flows. At step 276, the system may output an updated value of the resiliency metric for the target resource and the target region that indicates a maximum degree to which the total flow of the target resource to the target region will be disrupted when the particular route and one or more additional routes of the set of expected transportation routes are disrupted. Finally, at step 280, the system may generate an updated geospatial data image to the user that visually indicates the that resource flow along the transportation route will be disrupted and an expected impact of that disruption. The expected impact may be a change in resiliency scores as discussed above and in further detail below in connection with FIGS. 3-4, total changes in the quantities of resources flowing between regions, and the like, as non-limiting examples.

The FEWSION workflow is comprised of several unique algorithms to ingest, manipulate, analyze, and extract new, novel, unique and useful information from publicly-available datasets (or potentially private or sensitive datasets to which the system is given access) describing the production, consumption, and flow of food, energy, and water (FEW) in the United States (for instance) between an origin and destination, including foreign-based imports and exports. In general, the system works on any level of or detail of flows data-but especially “mesoscale” data that is aggregated.

Specifically, the FEWSION workflow achieves the overarching goal described above through the following steps:
(1) ingesting stock, flow, mode, route (i.e. commodity, good, service) datasets related to supply chains, stocks, and flows;
(2) extracting and classifying new flow granularities and categories from variously-aggregated and variously-categorized datasets (i.e. using the FEWSION codes);
(3) statistically downscaling commodity flows to a standard finer-granularity geographic and temporal scale at both the point of production and consumption using a variety of datasets that describe the production and consumption of food, energy, electricity, water, and industrial commodities, goods, services, stocks, and flows;
(4) downscaling global commodity flows from foreign regions to individual counties using foreign trade, remote sensing, and other various datasets to develop attraction factors;
(5) assigning production and consumption to economic sectors, including storage and flow of produced and consumed goods and services and commodities, using various standard controlled vocabularies (i.e. the 3-to-6 digit North American Industrial Classification System (NAICS) codes);
(6) embedding environmental and ecological attributes, footprints, emissions, impacts, and usages into the statistically-downscaled commodity flows;
(7) routing commodity flows from origin-to-destination using publicly-available infrastructure network data to show how a flow of food, energy, electricity, water, and industrial commodities get from origin to destination; and
(8) calculating a variety of novel network analytics on the production and consumption and flow of food, energy, electricity, water, industrial, and other commodities, goods, and services.

FEWSION data is downscaled to the county-level and finer, but can be re-aggregated to the metropolitan area and state scales for domestic origins and destinations and can be re-aggregated from individual commodities, to commodity sectors, and economic sectors. Using a proprietary algorithm, the FEWSION process produces a comprehensive database describing the flow of all kinds of economic and environmental goods and services in a geographic region. These data are widely useful for numerous professions including, but not limited to, academic researchers, city planners, economic planners, startup companies wishing to map the existing flow of foods and identify industrial feedstock, as well as emergency managers preparing for potential events. An initial, limited in scope method for downscaling commodity flows and embedding water use into the commodity flows was published by the NAU team (Rushforth, R. R., & Ruddell, B. L. “A spatially detailed and economically complete blue water footprint of the United States.” Hydrology and Earth System Science. 2018. https://doi.org/10.5194/hess-2017-650.)

FIG. 3 is a block-level flow diagram of an example FEWSION workflow as described in general terms above. The workflow can be divided into a series of broad steps, labeled 310, 320, 330, 340, and 350, and described in detail below. Each of these broad steps contains various sub-steps and elements which will are explained below with reference to additional sub-step/element labels.

Step 310: Data Merging. In the first step of the example FEWSION workflow of FIG. 3, commodity flow datasets from the U.S. Census Commodity Flow Survey and the Freight Analysis Framework (Step 0) produced by Oak Ridge National Laboratories and the Department of Transportation are ingested into the Merge Algorithm. The Merge Algorithm merges the two commodity flow datasets and separates out out-of-scope commodity-specific flows added by the Oak Ridge National Laboratories and the Department of Transportation. The out-of-scope flows extracted from the two datasets are natural gas, farm-based food, timber harvest, municipal solid waste, commercial and industrial waste, and demolition waste.

The dataset produced by the Merge & Extract Algorithm (Step 1) is an Initial FEWSION Commodity Flow Dataset that has the same geographic scale as the source data (la) and is analogous to the global resource flow records 132 depicted in FIG. 1. The resulting dataset (la) retains key attributes from both datasets that are vital for statistical downscaling. These attributes include:
a) the type of business that produces the good
b) the time of year of production of a good by a business type at the quarterly resolution,
c) the transit mode to transport a good between origin and destination,
d) refined global trading partner resolution, and
e) the origin, destination, and transport mode for out-of-scope commodities.

Additionally, and very importantly, the Initial FEWSION Commodity Flow Dataset retains fidelity with the source datasets. In a separate process, electricity flows are produced and incorporated into the Initial FEWSION Database and both are produced with data produced by the National Renewable Energy Laboratory and the Energy Information Administration, for instance. Finally, the algorithm identifies what supply chain step corresponds to each origin and destination, allowing the user to follow the supply chain to a desired step such as a warehouse or farm.

Step 320: Commodity Production and Consumption Downscaling. After the new commodity flow data are produced, datasets from the USDA, EIA, ORNL, EPA, BLS, DOT, USGS, and US Census, for instance (2a) are tested against the commodity flow data (la) to identify the most statistically significant regressors for each commodity with respect to commodity production and commodity demand. Once a regressor, or regressors, are identified for each commodity, production disaggregation factors are computed and used to disaggregate commodity flows at the point of production. In doing so, commodity production at the metropolitan area is disaggregated by first identifying which counties within that metropolitan area are connected to the transit mode of a commodity flow and then with respect to the relative share of an economic activity that produces a commodity within that metropolitan area. This process also identifies where goods are produced and passed through distribution hubs. Additionally, a disaggregation process occurs for international imports using US Census data to downscale from global regions to individual countries.

Similarly, a statistical process to determine demand disaggregation factors occurs and is used to disaggregate the commodity flows at the point of consumption. As part of the disaggregation process at the point of demand, data from the Bureau of Economic Analysis (3a) is used to proportion commodity inflows among economic sectors based on known consumptive use data from BEA (3). After this step, a similar process to step 2 and 2a are performed (Step 4 and 4a) to downscale commodity flow demand to the county level based on transit mode connectivity and the relative share of consumption activities within a metropolitan area. Additionally, a disaggregation process occurs for international exports using US Census data to downscale from global regions to individual countries. A limited-scope method for downscaling commodity flows and embedding water use into the commodity flows has been previously published (Rushforth and Ruddell, 2018, referenced above). Downscaled data such those produced in step 320 as described above may be used as localized resource data (e.g., localized resource data 134 as depicted in FIG. 1A and described in connection with systems and methods described in this disclosure).

Step 330: Embedding of Environmental Attributes. After commodity flows are downscaled at both the production side and the demand side, the environmental attributes are embedded into the commodity flows (5). For instance, these environmental attributes may include total virtual water withdrawals, virtual surface water withdrawals, virtual groundwater withdrawals, total virtual water consumption, virtual surface water consumption, virtual groundwater consumption, CO₂ emissions, CH₄ emissions, N₂O emissions, CO₂ emissions, SOX emissions, and NOₓ emissions. Other examples include ecological footprint information, HANPP information, and green virtual water information. Source data for the environmental attributes of trade are USGS and EPA, in the example of FIG. 3 (5a).

Step 340: Routing. At this point the flows are routed between on its specific transport mode between origin and destination (Steps 6 and 6a) to produce the Final FEWSION Database (Step 7). The data sources shown (labeled DOT and EIA to indicate data from the US Dept. of Transportation and the US Energy Information Administration, respectively) are non-limiting examples of resource transportation records described in connection with systems and methods disclosed herein (e.g., the resource transportation records 136 depicted in FIG. 1A). The routing algorithm first determines the shortest route(s) using a travel cost method between the centroid of an origins and the centroid of all destinations, or vice versa, for a given transit mode infrastructure network. Next, a novel algorithm decomposes the route network into unique constituent parts and sums the total flow over that specific segment, allowing for the visual representation of the accumulation of flows along an infrastructure network as they are produced and routed to a destination or vice routed from a point of production. FIG. 5 shows an example image output from the routing algorithm for food flows into Snohomish County, Wash., USA over the U.S. Interstate highway network. Relative quantities of resources along each transportation route segment may be represented as shown by width variations in the depicted flows between various locations along paths representing resource flows.

Step 350: Analytics. Referring again to FIG. 3, after the Final FEWSION Database (7) is produced, the commodity flow data are run through five or more network analytics algorithms (Step 8). Step 8 is shown in further detail in FIG. 3. For instance, the first two analytics algorithms are the dependence and leverage algorithms. These algorithms normalize origin-destination flow data on the origin (leverage) and destination (dependence). Next, a resilience metric is calculated for each destination and for each commodity flow dataset for each origin-destination pair and destination-origin pair (at all geographic scales) using a Shannon Diversity Index algorithm. The input layers into the resilience algorithm are outputs from the dependence and leverage datasets. Next, using outputs from the dependence algorithm and an input water stress index (or other stress index) dataset, the vulnerability algorithm generates data on supply chain water stress or indirect water stress. Methodologies for calculating the resilience and vulnerability analytics have been previously published (see Rushforth, R. R., & Ruddell, B. L. The vulnerability and resilience of a city's water footprint: The case of Flagstaff, Ariz., USA. Water Resources Research, 52(4), 2698-2714. 2016.).

Finally, a circularity metric is calculated from the dependence and leverage datasets. Circularity is the unique case where and origin and destination are the same location. Circularity is calculated from the dependence dataset indicates how much of what you consume is produced locally. Circularity calculated from the leverage dataset indicates how much of production is consumed locally. Finally, the Final FEWSION Commodity Flow dataset is run through the Blue Water Footprint algorithm to produce a blue water footprint dataset. The Final FEWSION Commodity Flow dataset, Dependence dataset, Leverage dataset, Vulnerability dataset, Resilience dataset, and Blue Water Footprint dataset are the component datasets of an Annual FEWSION Database (Step 9, FIG. 3). The Annual FEWSION Database contains data at the state- and county-level and can be summarized at the metropolitan-area-level.

Questions and user communities that need to be addressed using FEWSION data are several. What are all our dependencies? What are our adaptive and rerouting and locational options? How are we affected by distant events? Where does our food come from? How much of it is local? What are all the connections between the different layers within this system? These are the types of questions that you can answer when you have that entire system put together in one network dataset. A more thorough understanding of the FEW systems allows the development of more targeted policies that keep communities safer and more prosperous. It is critical to understand what resilience means in a connected world in order to engineer and build policies that will keep us safe and help us to be prosperous in this heavily-connected world.

To this end, the FEWSION project has developed FEW-View to allow the user to visually explore complex FEW system data using specific extracts of the core FEWSION database. The FEW-View tool is developed by Decision Theater® at Arizona State University with intellectual contributions and research funding from the FEWSION project's leaders at Northern Arizona University. FEW-View visualizes inputs and outputs, flows, supply chains, networks, and analytics thereof. FIG. 5, as described above is one example of an image generated to represent a dataset produced by FEWSION and presented by FEW-View. The core FEWSION database is a specific instantiation of a general class of data structure that describes inputs and outputs, flows, supply chains, networks, and analytics thereof. FEW-View provides generalizable visualization services for this class of data, making that data visually usable and accessible to specifically defined user communities. FEW-View could be used to visualize any data fitting this general class and type, but the initial implementation of FEW-View uses extracts of the core FEWSION database.

Users of FEW-View can either open scenarios that others have made or build their own scenario. A map of the U.S. is displayed upon opening the tool with markers across the map. Each of these markers is a pre-created scenario that users can open and explore. These pre-created scenarios are a great tool in the context of FEWSION and FEW systems to share knowledge and discoveries people make about local, regional, and national FEW systems.

Users of the tool can also build their own scenarios, selecting whatever regions or commodities that they desire in a selection panel on the left of the screen. Upon selecting one or more areas, FEW-View calculates the inflow and outflow of FEW resources and other commodities for the area by weight or percentage as well as how those goods flow. It will list the top contributing (or receiving locations) and highlights all contributing areas on the map. It will visually indicate the location and type of the largest flows on the map using geospatial arrows. In doing so, FEW-View turns scores of data that are difficult to read and understand into visualization that communicates the same exact information in an intuitive way, allowing for further exploration.

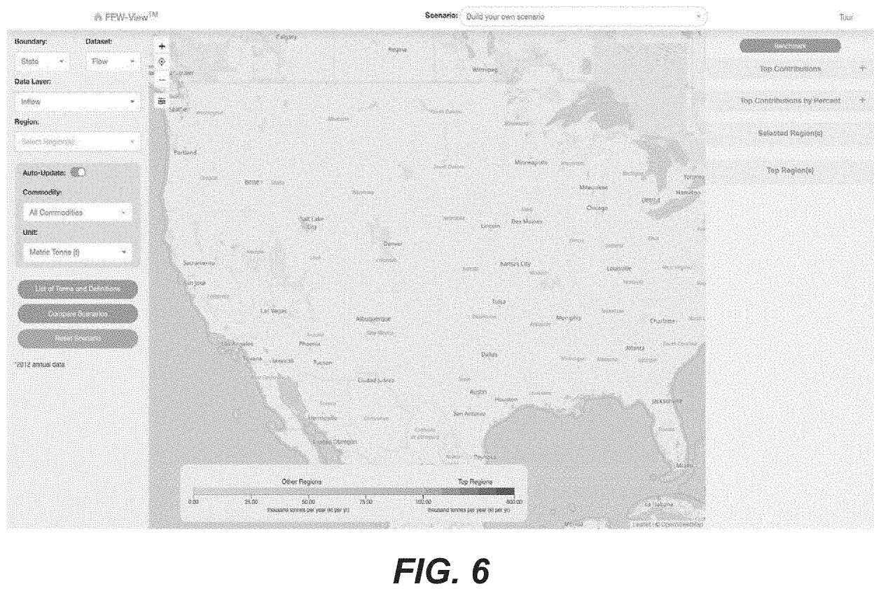

In “Build Your Own Scenario” users can select any location to see data on commodities, analytics, flows, etc. within that region and its network interactions with other regions, using a spatial map. An example user interface provided by FEW-View is shown in FIG. 6. In the example of FIG. 6, analysis and image generation will take place for the portion of North America shown. To perform an analysis and generate a data image, the user must first select whether they are using state or county boundaries. Then, the user can opt to examine data on the inflow/outflow of a commodity or view analytics such as dependence, leverage, circularity, resilience, vulnerability, and blue water footprint as described in the FEWSION workflow description.

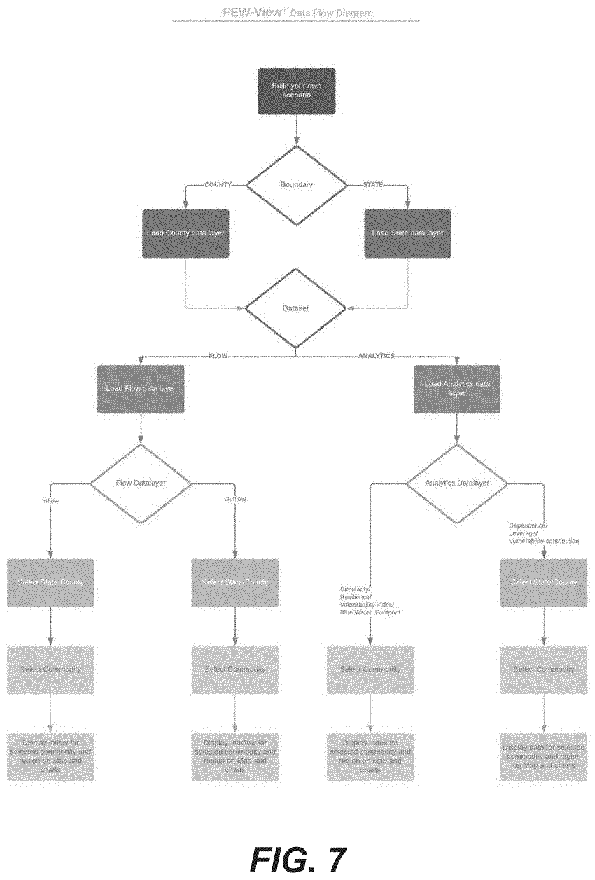

FIG. 7 is a flow diagram illustrating the process of determining which data image to generate based on selections made by a user through the FEW-View graphical user interface,

If “Flow” is selected user can focus on either the import of commodities, goods, services, or other flows (“Inflow”) or their export (“Outflow”). From here, the user can then select the specific region(s) they are interested in, as well as the flow they want to examine and what units they want FEW-View to measure those commodities with (e.g., dollars, weight, scientific and common units for energy and power commodities, virtual water, carbon emissions, and other air pollutants). From here, FEW-View takes over to gather the proper data and perform calculations before finally visualizing the data for easy user viewing. The data is primarily visualized through a map in the center and a panel to its right containing textual data and other minor visualization.

If “Analytics” is selected, the user is presented with a drop-down box from which they can select one of several sets of analytic data. Every analytics layer has its information that it represents, each of which has its own unique use. After selecting the analytics layer the user wants to view, they can then specify the region, commodity, and unit they want to analyze. Those three specifications, however, are not available for all datasets. For example, the resilience analytics compare all states in the United States across selected commodities. There is no need to select a region because that particular layer automatically selects all regions. The data from the analytics layers are then converted into visualization that have a similar format to the “Flow” visualizations. The visualizations may also include benchmarking visualizations which allow a user to see how one or more metrics for one region or set of regions compares with others, normalized, for example, to mean or median values for an entire chosen set of regions.

Examples of the analytics data sets that FEW-View uses are listed below. FEW-View can display an unlimited variety of network analytics for this class of data, but these are the currently implemented analytics (below).

Circularity: Measures the percentage of a commodity that is consumed within the region that it is produced in. It is displayed as a percentage.

Resilience (e.g. the Shannon Diversity Index): Measures the susceptibility of a commodity, or a set thereof, to disruptions in its supply chain. Circularity is measured on a scale of 0 to 1 with 1 being a maximally resilient supply chain with numerous suppliers.

Dependence: Measures the reliance of a supply chain on a specific supplier. It is communicated as a percentage, with 100% indicating that the largest supplier is responsible for supplying 100% of the commodity in the region. This specifically deals with the amounts of commodities by suppliers.

Leverage: Measures the prevalence of a specific supplier within a supply chain, measured as a percentage. While similar to dependence, this measures the overall number of suppliers instead of the amount of a commodity from each supplier.

Vulnerability Index: This measures the vulnerability drought can have on a supply chain measured from 0 to 1. In this case, 1 represents a supply chain that relies most heavily on suppliers who have stressed water supplies.

Vulnerability Contribution: This measures the vulnerability drought can have on a supply chain measured from 0 to 1. In this case, 1 represents a supply chain that relies most heavily on suppliers who have stressed water supplies.

Blue Water Footprint: The total freshwater consumption within the boundaries of a state, defined as all personal consumption by people combined with its virtual-water balance. Virtual water is the sum total of all water used up by a commodity during its production. The virtual water balance is the amount of virtual water used by its gross import minus the virtual water used by its gross exports.

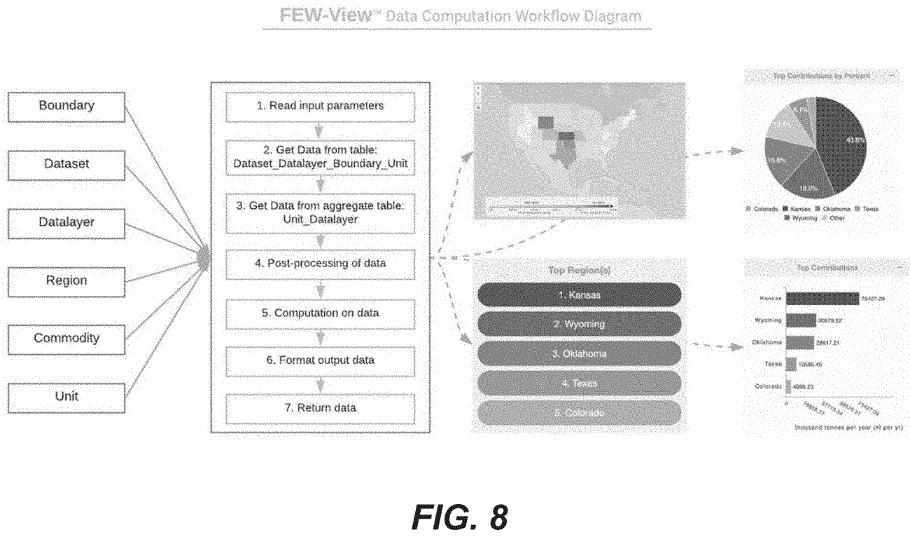

The core power of the FEW-View lies in the backend computations that processes millions of data points and displays the results to the user in multiple, easily consumable visual formats. Any changes a user makes to parameter, will trigger an API call to send a request to the backend computation engine. The backend system will read all the parameters passed to it and retrieve data from the main and aggregate tables in the database. Once the data is retrieved, it will be cleaned and analyzed. Finally, the engine will calculate several variables used to generate a data image containing the data and representing it visually. FIG. 8 is an overview of the FEW-View computation workflow which is used to produce data images.

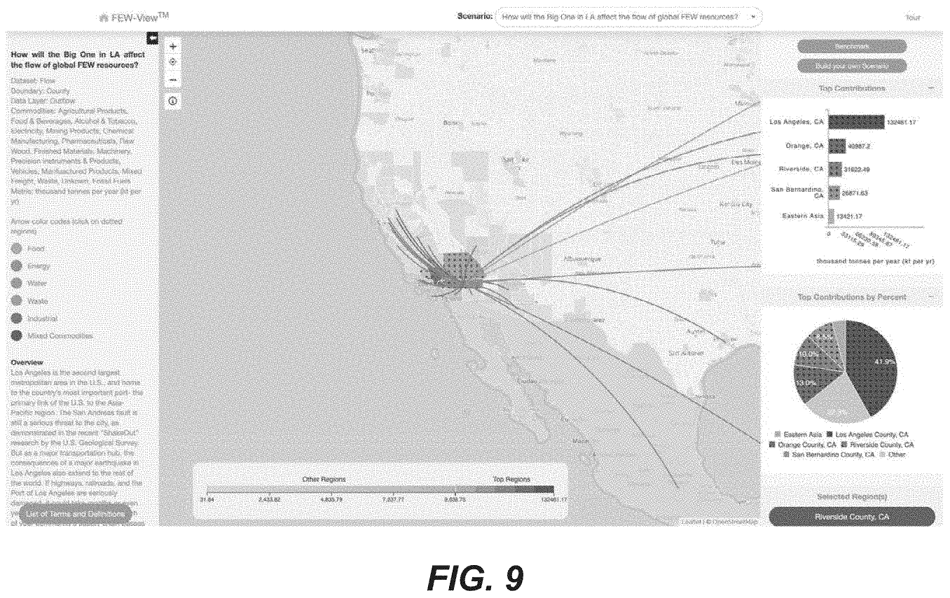

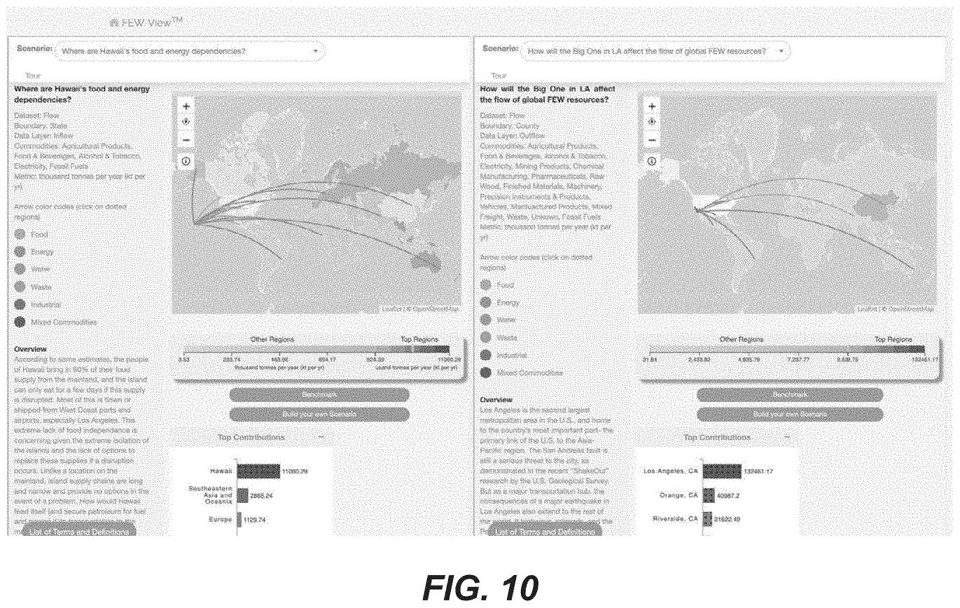

FIG. 9 shows a scenario page for a pre-selected scenario and the resulting data image. The scenario page consists of three sections, left sidebar has information about the scenario name, the parameters selected for the scenario, information about the color codes, scenario description, and terms button. The middle part of the page consists of the map, which is visualized based on the data for the scenario. The map also shows arrows which determine how selected commodities flow between the regions. The color of the arrows talks about the dominant commodity that is being transported. Map also has a legend at the bottom which differentiates the top N regions and other regions. Top N regions highlight the N regions which has a higher share in the trade, and all other regions come under other regions category. The right sidebar has the option to view the Benchmarking, Build your own scenario, some graphs which visually represent the data presented on the map, selected regions and top regions. The data images generated from different scenarios may be compared. FIG. 10 shows an example of side-by-side comparison of two scenarios.

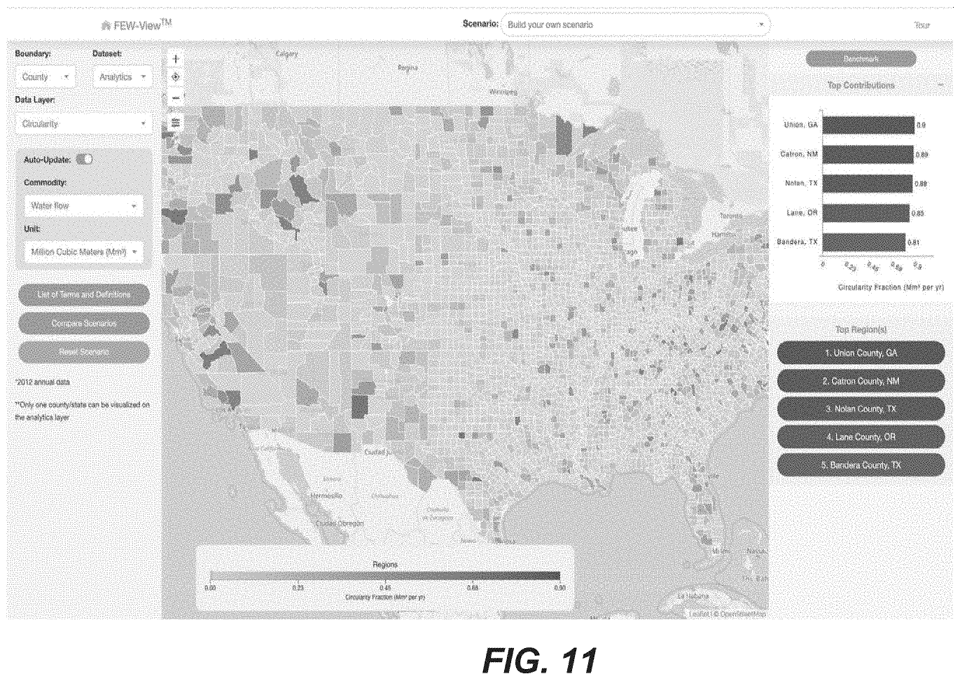

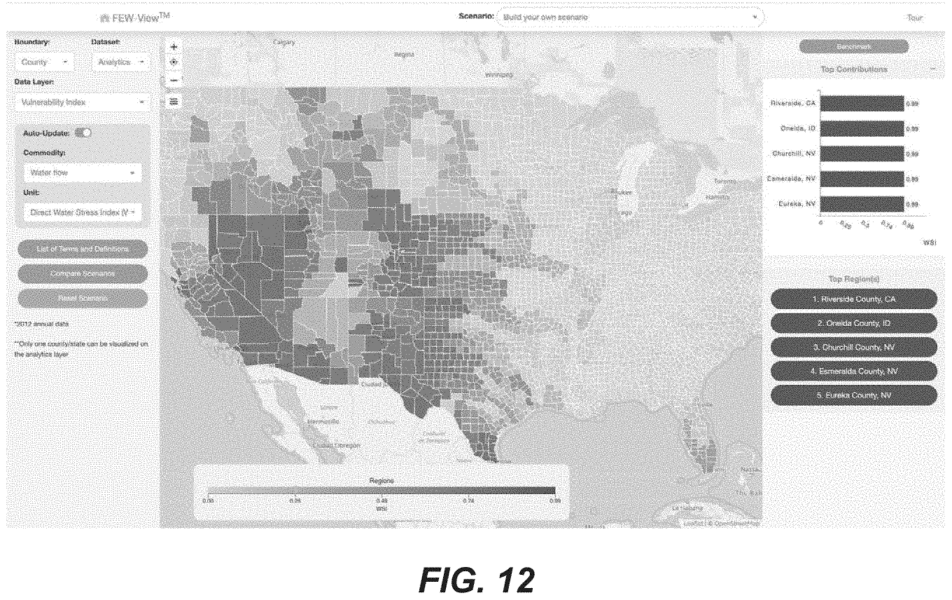

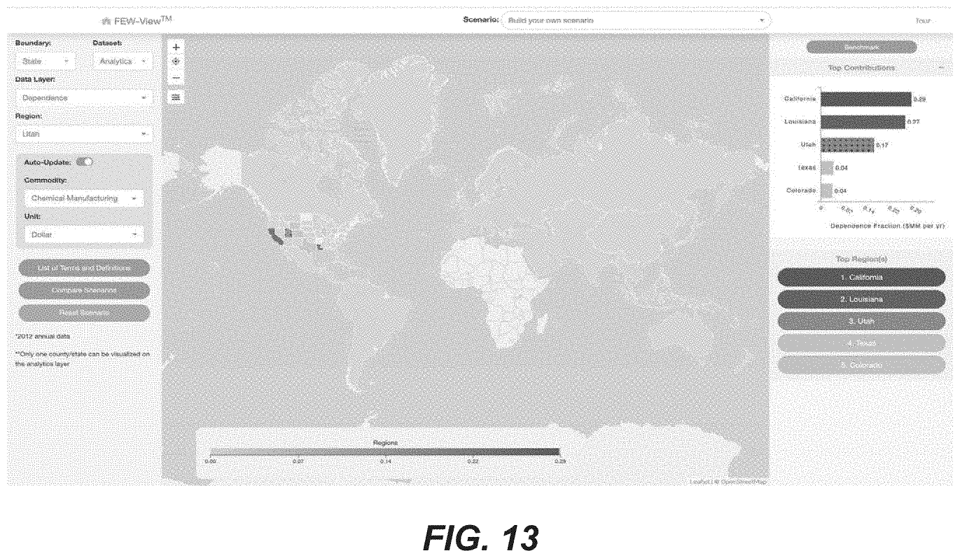

FIGS. 11-13 show example data images of analytic metrics on different scales. FIG. 11 shows county-level water flow circularity for the continental United States. FIG. 11 shows county-level water flow vulnerability for the continental United States. FIG. 13 shows global state-level dependence of chemical manufacturing for the state of Utah (in this example, US states are rendered as individual regions, while foreign countries are divided into broader regions that may span multiple countries).

The invention claimed is:

1. A system comprising:
a database server configured to provide remote access to a set of electronic datastores storing:
global resource flow records, each resource flow record indicating an origin, destination, quantity, and classification of resources transferred between the origin and destination regions belonging to a set of geographic regions, the global resource flow records having a first level of geographic granularity and identifying resources at a first level of category granularity;
localized resource records indicating quantities of resources consumed or produced in sub-regions within the set of geographic regions, the localized resource records having a second level of geographic granularity greater than the first level of geographic granularity and a second level of category granularity greater than or equal to the first level of category granularity;
a communication network coupled to the database server;
a user device coupled to the communication network, comprising: a processor; a display device coupled to the processor; and memory coupled to the processor storing instructions that when executed by the processor cause the processor to:
provide a user interface via the display device;
receive an initial geospatial image within the user interface;
receive user inputs directed toward image coordinates of the geospatial image;
generate user interaction signals that encode the image coordinates and analysis commands identifying a target resource and requested transformations of the initial geospatial image;
transmit the user interaction signals and the analysis commands to a remote server; and
display a geospatial data image that fuses the initial geospatial image with geospatially-represented data elements, the geospatial data image representing results of the requested analysis; and
a rendering server comprising: processing circuitry, a communications interface coupled to the processing circuitry and the communications network; and memory coupled to the processing circuitry, the memory storing rendering instructions that, when executed by the processing circuitry, cause the processing circuitry to:
receive the user interaction signals from the user device;
determine a geographic extent for the geospatial data image using the user interaction signals;
determine a target region within the set of geographic regions by:
accessing boundary data describing boundaries within the set of geographic regions; and
outputting, as the target region, a sub-region specified at a third level of geographic granularity greater than the first level of geographic granularity and belonging to a first region within the set of geographic regions that includes the image coordinates;
calculate, using the global resource flow records, resource flows of the target resource to the first region from each of set of sources for the target resource;
transform the calculated resource flows of the target resource to the first region into graphic representations of resource flows of the target resource to the target region by:
determining, using the localized resource records, a total flow of the target resource to the target region from the set of sources for the target resource;
determining, using the total flow of the target resource to the target region and the calculated resource flows of the of the target resource to the first region, a set of flows of the target resource to the target region corresponding to the set of sources for the target resource; and
generating, for each flow of the target resource to the target region, a set of coordinates forming one or more paths from a source of that flow to the target region in a coordinate system of the initial geospatial image, each path having a width parameter determined by a magnitude of that flow of the target resource to the target region;
render the geospatial data image by replacing pixel color values of pixels at coordinates of each path in the initial geospatial image with a color value absent from the initial geospatial image; and
transmit the geospatial data image to the user device.

2. The system of claim 1,
wherein the database server further stores resource transportation data associating quantities of resources with transportation modalities used to transport those resources; and transportation network image data representing transportation networks within the set of geographic regions, the transportation network images having a degree of geographic granularity greater than the first degree of geographic granularity; and
wherein the rendering instructions, when executed by the processing circuitry to generate the set of coordinates for each flow of the target resource to the target region, cause the processing circuitry to:
extract resource transportation records from the resource transportation data, each resource transportation record indicating a corresponding transportation modality associated with one of: the target resource or a resource category to which the target resource belongs; and
determine, for each flow belonging to the set of flows of the target resource to the target region, one or more expected transportation routes represented in the transportation network images for that flow using the resource transportation records and the transportation network images;

3. The system of claim 2, wherein the rendering instructions, when executed by the processing circuitry to render the geospatial data image, cause the processing circuitry to:
assign a sizing parameter to each path that determines a width of that path, wherein the sizing parameter for each path is monotonically related to a quantity of resources flowing along that path.

4. The system of claim 2, wherein the rendering instructions, when executed by the processing circuitry, further cause the processing circuitry to:
derive a first resiliency value of a resiliency metric for the target region, the first resiliency value indicating a maximum degree to which a total flow quantity of the target resource to the target region will be disrupted when one or more of the expected transportation routes is disrupted; and
determine a subset of the subset of the resource flows to the target region sufficient to lower the first resiliency metric value below a predetermined threshold if the subset of the resource flows to the target region is disrupted;

5. The system of claim 4, wherein the processing circuitry is configured to receive real-time signals indicating disruptions to one or more transportation routes and wherein the rendering instructions, when executed by the processing circuitry further cause the processing circuitry to:
receive a signal indicating disruption of an affected transportation route;
determine that coordinates of the affected transportation route overlap at least part of a particular route belonging to the set of expected transportation routes represented in the transportation network images;
determine that no alternate route to the particular route having an origin of the particular route and having a value of the cost function equal to or less than maximum acceptable cost value exists between the origin of the particular route and the target region;
output an updated value of the resiliency metric for the target resource and the target region indicating a maximum degree to which the total flow of the target resource to the target region will be disrupted when the particular route and one or more additional routes of the set of expected transportation routes are disrupted;
modify the geospatial data image by altering the sets of color values assigned to each resource flow such that:
pixel values along paths representing the one or more additional routes are assigned a first set of color values;
pixel values along paths representing particular route are assigned a second set of color values; and
pixel values along paths representing resource flows are assigned a third set of color values; and
transmit the modified geospatial data image to the user device.

6. The system of claim 5, wherein the rendering instructions, when executed by the processing circuitry cause the processing circuitry to:
determine, using at least the first resiliency value and the updated resiliency value, that a future resiliency value for the target resource and the target region is expected to drop below a predetermined threshold within a predetermined time interval; and
transmit, to the user device, a second updated geospatial data image including an alert to the user that the future resiliency value for the target resource and the target region is expected to drop below the predetermined threshold.

7. The system of claim 4 wherein, the memory stores further instructions that, when executed by the processing circuitry cause the processing circuitry to:
receive a user interface signal indicating a request to identify significant resource hubs within a selected geographic region;
determine, using the global resource flow records, the localized resource records, the resource transportation data, and the transportation network image data: respective quantities of selected resources transported through a candidate hub region to a set of destination regions;
derive respective baseline resiliency values of the resiliency metric, for the selected resources and each destination region when the selected resources are allowed to travel through the candidate hub region;
derive respective adjusted resiliency values of the resiliency metric, for the selected resources and each destination region when the selected resources are not allowed to travel through the candidate hub region; and
in response to determining that an aggregate value of the adjusted resiliency values is smaller than an aggregate value of the baseline resiliency values, display an updated geospatial data image to the user that visually indicates that the candidate hub region is a significant resource hub.

8. The system of claim 4, wherein deriving the first resiliency value of the resiliency metric for the target resource and the target region comprises using the quantities of the target resource transported to the target region via each of the set of expected transportation routes as inputs to an entropy-based economic diversity function.

9. A system comprising processing circuitry and memory coupled to the processing circuitry, the memory storing instructions that when executed by the processing circuitry cause the processing circuitry to:
provide a user interface to a user device, the user interface configured to display geospatial images and capture interactions of a user with the geospatial images;
retrieve, from an electronic datastore:
global resource flow records, each resource flow record indicating an origin, destination, quantity, and classification of resources transferred between the origin and destination regions belonging to a set of geographic regions, the global resource flow records having a first level of geographic granularity and identifying resources at a first level of category granularity; and
localized resource records indicating quantities of resources consumed or produced in sub-regions within first set of geographic regions, the localized resource records having a second level of geographic granularity greater than the first level of geographic granularity and a second level of category granularity greater than or equal to the first level of category granularity;
transmit an initial geospatial image to the user device via the user interface representing the first set of geographic regions;
receive, from the user device via the user interface, user interaction signals encoding image coordinates and analysis commands identifying a target resource and requested transformations of the initial geospatial image;
determine a geographic extent for a geospatial data image using the user interaction signals;
determine a target region within the set of geographic regions by:
accessing boundary data describing boundaries within the set of geographic regions; and
outputting, as the target region, a sub-region specified at a third level of geographic granularity greater than the first level of geographic granularity and belonging to a first region within the set of geographic regions that includes the image coordinates;
calculate, using the global resource flow records, resource flows of the target resource to the first region from each of set of sources for the target resource;
transform the calculated resource flows of the target resource to the first region into graphic representations of resource flows of the target resource to the target region by:
determining, using the localized resource records, a total flow of the target resource to the target region from the set of sources for the target resource;
determining, using the total flow of the target resource to the target region and the calculated resource flows of the of the target resource to the first region, a set of flows of the target resource to the target region corresponding to the set of sources for the target resource; and
generating, for each flow of the target resource to the target region, a set of coordinates forming one or more paths from a source of that flow to the target region in a coordinate system of the initial geospatial image, each path having a width parameter determined by a magnitude of that flow of the target resource to the target region;
render the geospatial data image by replacing pixel color values of pixels at coordinates of each path in the initial geospatial data image with a color value absent from the initial geospatial image; and
transmit the geospatial data image to the user device.

10. The system of claim 9, wherein the instructions, when executed by the processing circuitry, further cause the processing circuitry to:
retrieve, from the electronic datastore, resource transportation data associating quantities of resources with transportation modalities used to transport those resources; and
transportation network image data representing transportation networks within the set of geographic regions, the transportation network images having a level of geographic granularity greater than the first level of geographic granularity;
wherein the instructions, when executed by the processing circuitry to generate the set of coordinates for each flow of the target resource to the target region, cause the processing circuitry to:
extract resource transportation records from the resource transportation data, each resource transportation record indicating a corresponding transportation modality associated with one of: the target resource or a resource category to which the target resource belongs; and
determine, for each flow belonging to the set of flows of the target resource to the target region, one or more expected transportation routes represented in the transportation network images for that flow using the resource transportation records and the transportation network images; and
assign a sizing parameter to each path that determines a width of that path, wherein the sizing parameter for each path is monotonically related to a quantity of resources flowing along that path.

11. The system of claim 9, wherein the instructions, when executed by the processing circuitry, further cause the processing circuitry to:
derive a first resiliency value of a resiliency metric for the target region, the first resiliency value indicating a maximum degree to which a total flow quantity of the target resource to the target region will be disrupted when one or more of the expected transportation routes is disrupted; and
determine a subset of the subset of the resource flows to the target region sufficient to lower the first resiliency metric value below a predetermined threshold if the subset of the resource flows to the target region is disrupted;

12. The system of claim 11, wherein the processing circuitry is configured to receive real-time signals indicating disruptions to one or more transportation routes and wherein the instructions, when executed by the processing circuitry further cause the processing circuitry to:
receive a signal indicating disruption of an affected transportation route;
determine that coordinates of the affected transportation route overlap at least part of a particular route belonging to the set of expected transportation routes represented in the transportation network images;
determine that no alternate route to the particular route having an origin of the particular route and having a value of the cost function equal to or less than maximum acceptable cost value exists between the origin of the particular route and the target region;
output an updated value of the resiliency metric for the target resource and the target region indicating a maximum degree to which the total flow of the target resource to the target region will be disrupted when the particular route and one or more additional routes of the set of expected transportation routes are disrupted;
modify the geospatial data image by altering the sets of color values assigned to each resource flow such that:
pixel values along paths representing the one or more additional routes are assigned a first set of color values;
pixel values along paths representing particular route are assigned a second set of color values; and
pixel values along paths representing resource flows are assigned a third set of color values; and
transmit the modified geospatial data image to the user device.

13. The system of claim 11, the memory stores further instructions that, when executed by the processing circuitry cause the processing circuitry to:
receive a user interface signal indicating a request to identify significant resource hubs within a selected geographic region;
determine, using the global resource flow records, the localized resource records, the resource transportation data, and the transportation network image data: respective quantities of selected resources transported through a candidate hub region to a set of destination regions;
derive respective baseline resiliency values of the resiliency metric, for the selected resources and each destination region when the selected resources are allowed to travel through the candidate hub region;
derive respective adjusted resiliency values of the resiliency metric, for the selected resources and each destination region when the selected resources are not allowed to travel through the candidate hub region; and
in response to determining that an aggregate value of the adjusted resiliency values is smaller than an aggregate value of the baseline resiliency values, transmit an updated geospatial data image to the user device that visually indicates that the candidate hub region is a significant resource hub.

14. The system of claim 11, wherein deriving the first resiliency value of the resiliency metric for the target resource and the target region comprises using quantities of the target resource transported to the target region via each of the set of expected transportation routes as inputs to an entropy-based economic diversity function.

15. A method comprising:
providing a user interface to a user device, the user interface configured to display geospatial images and capture interactions of a user with the geospatial images;
retrieving, from an electronic datastore:
global resource flow records, each resource flow record indicating an origin, destination, quantity, and classification of resources transferred between the origin and destination regions belonging to a set of geographic regions, the global resource flow records having a first level of geographic granularity and identifying resources at a first level of category granularity; and
localized resource records indicating quantities of resources consumed or produced in sub-regions within first set of geographic regions, the localized resource records having a second level of geographic granularity greater than the first level of geographic granularity and a second level of category granularity greater than or equal to the first level of category granularity;
transmitting a geospatial data image to the user via the user interface representing the first set of geographic regions;
receiving, from the user device via the user interface, user interaction signals encoding image coordinates and analysis commands identifying a target resource and requested transformations of the initial geospatial image;
determining a geographic extent for a geospatial data image using the user interaction signals;
determining a target region within the set of geographic regions by:
accessing boundary data describing boundaries within the set of geographic regions; and
outputting, as the target region, a sub-region specified at a third level of geographic granularity greater than the first level of geographic granularity and belonging to a first region within the set of geographic regions that includes the image coordinates;
calculating, using the global resource flow records, resource flows of the target resource to the first region from each of set of sources for the target resource;
transforming the calculated resource flows of the target resource to the first region into graphic representations of resource flows of the target resource to the target region by:
determining, using the localized resource records, a total flow of the target resource to the target region from the set of sources for the target resource;
determining, using the total flow of the target resource to the target region and the calculated resource flows of the of the target resource to the first region, a set of flows of the target resource to the target region corresponding to the set of sources for the target resource;
generating, for each flow of the target resource to the target region, a set of coordinates forming one or more paths from a source of that flow to the target region in a coordinate system of the initial geospatial image, each path having a width parameter determined by a magnitude of that flow of the target resource to the target region;
rendering the geospatial data image by replacing pixel color values of pixels at coordinates of each path in the initial geospatial data image with a color value absent from the initial geospatial image; and
transmitting the geospatial data image to the user device.

16. The method of claim 15, the method further comprising:
retrieving, from the electronic datastore, resource transportation data associating quantities of resources with transportation modalities used to transport those resources; and transportation network image data representing transportation networks within the set of geographic regions, the transportation network images having a level of geographic granularity greater than the first level of geographic granularity;
extracting resource transportation records from the resource transportation data, each resource transportation record indicating a corresponding transportation modality associated with one of: the target resource or a resource category to which the target resource belongs; and
determining, for each flow belonging to the set of flows of the target resource to the target region, one or more expected transportation routes represented in the transportation network images for that flow using the resource transportation records and the transportation network images; and
assigning a sizing parameter to each path that determines a width of that path, wherein the sizing parameter for each path is monotonically related to a quantity of resources flowing along that path.

17. The method of claim 15, the method further comprising:
deriving a first resiliency value of a resiliency metric for the target region, the first resiliency value indicating a maximum degree to which a total flow quantity of the target resource to the target region will be disrupted when one or more of the expected transportation routes is disrupted; and
determining a subset of the subset of the resource flows to the target region sufficient to lower the first resiliency metric value below a predetermined threshold if the subset of the resource flows to the target region is disrupted.

18. The method of claim 17, further comprising:
receiving a signal indicating disruption of an affected transportation route;
determining that coordinates of the affected transportation route overlap at least part of a particular route belonging to the set of expected transportation routes represented in the transportation network images;
determining that no alternate route to the particular route having an origin of the particular route and having a value of the cost function equal to or less than maximum acceptable cost value exists between the origin of the particular route and the target region;
outputting an updated value of the resiliency metric for the target resource and the target region indicating a maximum degree to which the total flow of the target resource to the target region will be disrupted when the particular route and one or more additional routes of the set of expected transportation routes are disrupted;
modifying the geospatial data image by altering the sets of color values assigned to each resource flow such that:
pixel values along paths representing the one or more additional routes are assigned a first set of color values;
pixel values along paths representing particular route are assigned a second set of color values; and
pixel values along paths representing resource flows are assigned a third set of color values; and
transmitting the modified geospatial data image to the user device.

19. The system of claim 17, the memory stores further instructions that, when executed by the processing circuitry cause the processing circuitry to:
receive a user interface signal indicating a request to identify significant resource hubs within a selected geographic region;
determine, using the global resource flow records, the localized resource records, the resource transportation data, and the transportation network image data: respective quantities of selected resources transported through a candidate hub region to a set of destination regions;
derive respective baseline resiliency values of the resiliency metric, for the selected resources and each destination region when the selected resources are allowed to travel through the candidate hub region;
derive respective adjusted resiliency values of the resiliency metric, for the selected resources and each destination region when the selected resources are not allowed to travel through the candidate hub region; and
in response to determining that an aggregate value of the adjusted resiliency values is smaller than an aggregate value of the baseline resiliency values, transmit an updated geospatial data image to the user device that visually indicates that the candidate hub region is a significant resource hub.

20. The system of claim 17, wherein deriving the first resiliency value of the resiliency metric for the target resource and the target region comprises using the quantities of the target resource transported to the target region via each of the set of expected transportation routes as inputs to an entropy-based economic diversity function.
